(19) United States
(12) Patent Application Publication
(10) Pub. No.: US 2026/0124536 A1
(43) Pub. Date: May 7, 2026

(54) NON-TRANSITORY COMPUTER READABLE MEDIUM, INFORMATION PROCESSING METHOD, AND GAME APPARATUS

(71) Applicant: Cygames, Inc., Tokyo (JP)

(72) Inventors: Ryo Ota, Tokyo (JP); Miku Yoshimura, Tokyo (JP); Yasunori Horino, Tokyo (JP); Suguru Tamura, Tokyo (JP); Masaki Sugiyama, Tokyo (JP)

(73) Assignee: CYGAMES, INC., Tokyo (JP)

(21) Appl. No.: 19/440,161

(22) Filed: Jan. 5, 2026

Related U.S. Application Data
(63) Continuation of application No. PCT/JP2024/026505, filed on Jul. 24, 2024.

(30) Foreign Application Priority Data
Aug. 2, 2023 (JP) 2023-126267

(51) Int. Cl. A63F 13/533

(52) U.S. Cl. CPC A63F 13/533

(57) ABSTRACT

A non-transitory computer readable medium stores a program causing a computer to execute: processing of causing a player to select one or more objects from among a plurality of types of objects displayable on a standby screen displayed during loading of data; processing of storing the one or more objects selected by the player as displayable objects, and setting, based on an operation input from the player, position information defining a display position of each of the one or more objects on the standby screen; and processing of displaying, during the loading of the data, information indicating that the data is being loaded on the standby screen, and displaying, based on the position information, the one or more objects stored as the displayable objects on the standby screen.

### CROSS REFERENCE TO RELATED APPLICATIONS

This application is a continuation application of International Application No. PCT/JP2024/026505, filed on Jul. 24, 2024, which claims priority to Japanese Patent Application No. 2023-126267, filed on Aug. 2, 2023, the entire contents of which are incorporated by reference herein.

### BACKGROUND ART

### Technical Field

The present invention relates to an information processing program, an information processing method, and a game apparatus.

In the related art, a technology for displaying an image for animation on a game screen during data loading has been proposed as described in, for example, Patent Document 1. The image for animation is displayed during the data loading, thereby reducing player fatigue.

### CITATION LIST

### Patent Literature

Patent Document 1: JP 2020-44161 A

### SUMMARY OF INVENTION

### Technical Problem

However, when image display patterns are limited, the player may become bored of viewing the images and gradually feel fatigued.

An object of the present invention is to provide an information processing program, an information processing method, and a game apparatus that can suppress player fatigue.

### Solution to Problem

In order to solve the above problem, an information processing program causes a computer to execute:
processing of causing a player to select one or more objects from among a plurality of types of objects displayable on a standby screen displayed during loading of data,
processing of storing the one or more objects selected by the player as displayable objects, and setting, based on an operation input from the player, position information defining a display position of each of the one or more objects on the standby screen, and
processing of displaying, during the loading of the data, information indicating that the data is being loaded on the standby screen, and displaying, based on the position information, the one or more objects stored as the displayable objects on the standby screen.

The information processing program may cause the computer to execute:
processing of setting the number of the one or more objects to be displayed on the standby screen based on an operation input from the player; and
processing of determining, by lottery, the same number of the displayable objects as the number of the one or more objects to be displayed on the standby screen, from among the stored displayable objects, wherein
the processing of displaying the one or more objects on the standby screen may include displaying, as the one or more objects, all the displayable objects determined by the lottery on the standby screen.

The processing of determining the displayable objects by the lottery may be executed every time the standby screen is displayed.

In order to solve the above problem, an information processing method is an information processing method executed by one or more computers, the information processing method including:
by the one or more computers, processing of causing a player to select one or more objects from among a plurality of types of objects displayable on a standby screen displayed during loading of data,
by the one or more computers, processing of storing the one or more objects selected by the player as displayable objects, and setting, based on an operation input from the player, position information defining a display position of each of the one or more objects on the standby screen, and
by the one or more computers, processing of displaying, during the loading of the data, information indicating that the data is being loaded on the standby screen, and displaying, based on the position information, the one or more objects stored as the displayable objects on the standby screen.

In order to solve the above problem, a game apparatus includes:
one or more computers, wherein
the one or more computers execute:
processing of causing a player to select one or more objects from among a plurality of types of objects displayable on a standby screen displayed during loading of data;
processing of storing the one or more objects selected by the player as displayable objects, and setting, based on an operation input from the player, position information defining a display position of each of the one or more objects on the standby screen; and
processing of displaying, during the loading of the data, information indicating that the data is being loaded on the standby screen, and displaying, based on the position information, the one or more objects stored as the displayable objects on the standby screen.

### Effects of Disclosure

According to the present invention, it is possible to suppress player fatigue.

### BRIEF DESCRIPTION OF DRAWINGS

FIG. 1 is an explanatory diagram illustrating a schematic configuration of an information processing system.

FIG. 2A is a diagram for describing a hardware configuration of a player terminal. FIG. 2B is a diagram for describing a hardware configuration of a server.

FIG. 3 is a diagram illustrating an example of a standby screen.

FIG. 4 is a diagram for describing an example of a stamp book top screen.

FIG. 5A is a first diagram for describing a stamp settings screen. FIG. 5B is a second diagram for describing the stamp settings screen.

FIG. 6A is a diagram for describing a standby screen in a one-image setting state. FIG. 6B is a diagram for describing a standby screen in a two-image setting state.

FIG. 7 is a diagram for describing a relationship between the number of stamp images displayed on the standby screen and the number of stamp images in a selected state.

FIG. 8 is a diagram for describing a configuration of a memory in the player terminal and a function thereof as a 15 computer.

FIG. 9 is a flowchart for describing an example of lottery game execution processing in the player terminal.

FIG. 10 is a flowchart for describing an example of stamp-related screen display processing in the player 20 terminal.

FIG. 11 is a flowchart for describing an example of stamp setting processing in the player terminal.

FIG. 12 is a flowchart for describing an example of standby screen display processing in the player terminal.

### DESCRIPTION OF EMBODIMENTS

Hereinafter, an aspect of an embodiment of the present invention will be described in detail with reference to the accompanying drawings. Dimensions, materials, specific numerical values, and the like described in the embodiment are merely examples for facilitating understanding and do not limit the present invention unless otherwise specified. In this description and the drawings, elements having substantially the same function and configuration are denoted by the same reference numerals, and redundant description thereof will be omitted, and elements not directly relating to the present invention will not be illustrated.

### Overall Configuration of Information Processing System S

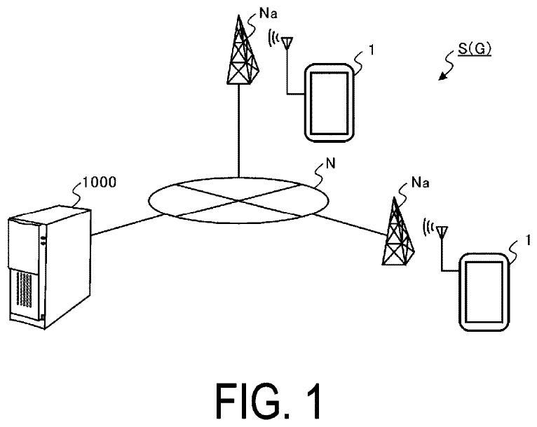

FIG. 1 is an explanatory diagram illustrating a schematic configuration of an information processing system S. The information processing system S is a so-called client-server system including a player terminal 1, a server 1000, and a communication network N including a communication base station Na.

The player terminal 1 can establish communication with the server 1000 via the communication network N. The player terminal 1 widely includes an electronic device capable of establishing a wireless or wired communication connection to the server 1000. Examples of the player terminal 1 include a smartphone, a mobile phone, a tablet device, a personal computer, or a game console. In the present embodiment, a case where a smartphone is used as the player terminal 1 will be described.

The server 1000 is communicatively connected to a plurality of player terminals 1. The server 1000 accumulates various types of information (player information) for each player who plays a game. In addition, the server 1000 updates the accumulated information based on an operation input from the player terminal 1.

The communication base station Na is connected to the communication network N and wirelessly exchanges information with the player terminal 1. The communication network N is implemented as a cellular network, an Internet network, a local area network (LAN), a dedicated line, or the like, and establishes a wireless or wired communication connection between the player terminal 1 and the server 1000.

In the information processing system S of the present embodiment, the player terminal 1 and the server 1000 function as a game apparatus G. Each of the player terminal 1 and the server 1000 has a role of controlling the progress of the game, and the game can progress through cooperation between the player terminal 1 and the server 1000.

### Hardware Configurations of Player Terminal 1 and Server 1000

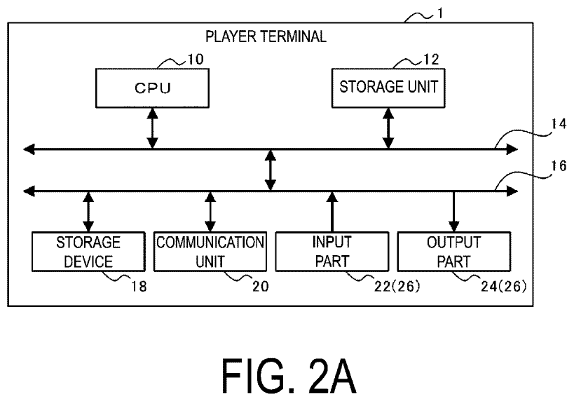

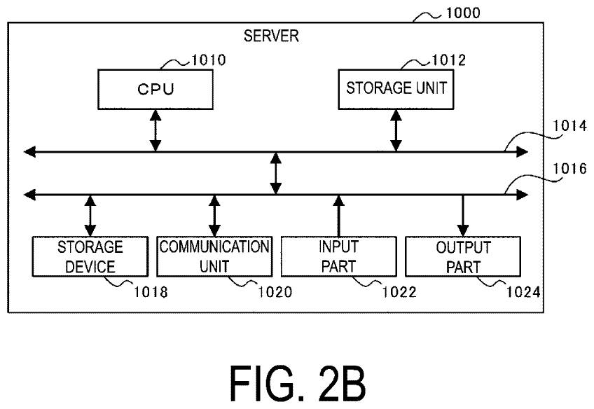

FIG. 2A is a diagram for describing a hardware configuration of the player terminal 1. FIG. 2B is a diagram for describing a hardware configuration of the server 1000. As illustrated in FIG. 2A, the player terminal 1 includes a central processing unit (CPU) 10, a storage unit 12, a bus 14, an input/output interface 16, a storage device 18, a communication unit 20, an input part 22, and an output part 24.

As illustrated in FIG. 2B, the server 1000 includes a CPU 1010, a storage unit 1012, a bus 1014, an input/output interface 1016, a storage device 1018, a communication unit 1020, an input part 1022, and an output part 1024.

The configurations and functions of the CPU 1010, the storage unit 1012, the bus 1014, the input/output interface 1016, the storage device 1018, the communication unit 1020, the input part 1022, and the output part 1024 of the server 1000 are substantially and respectively the same as the CPU 10, the storage unit 12, the bus 14, the input/output interface 16, the storage device 18, the communication unit 20, the input part 22, and the output part 24 of the player terminal 1. Thus, the hardware configuration of the player terminal 1 will be described below, but description of the server 1000 will be omitted.

The CPU 10 operates programs stored in the storage unit 12 to control the progress of the game. The storage unit 12 is implemented as a read only memory (ROM) or a random access memory (RAM) and stores programs and various types of data necessary for controlling the progress of the game. The storage unit 12 is connected to the CPU 10 via the bus 14.

The input/output interface 16 is connected to the bus 14. The storage device 18, the communication unit 20, the input part 22, and the output part 24 are connected to the input/output interface 16.

The storage device 18 is implemented as a semiconductor memory and stores various types of programs and data. In the player terminal 1, the programs and data stored in the storage device 18 are loaded into the storage unit 12 by the CPU 10.

The communication unit 20 is wirelessly and communicatively connected to the communication base station Na and exchanges information such as various types of data and programs with the server 1000 via the communication network N. In the player terminal 1, programs or the like received from the server 1000 are stored in the storage unit 12 or the storage device 18.

The input part 22 is implemented as, for example, a touch panel, a button, a keyboard, a mouse, a four-direction key, an analog controller, and the like for inputting operations (receiving operations) of the player. Alternatively, the input part 22 may be a dedicated controller provided in the player terminal 1 or connected (externally attached) to the player terminal 1. Furthermore, the input part 22 may be implemented as an acceleration sensor that detects the inclination or movement of the player terminal 1 or a microphone that detects audio from the player. That is, the input part 22 widely includes apparatuses that allow the player to identifiably input their intention.

The output part 24 is implemented as a display apparatus and a speaker. Note that the output part 24 may be a device connected (externally attached) to the player terminal 1. In the present embodiment, the player terminal 1 includes a touch panel 26 that functions as the input part 22 and the output part 24.

Next, details of a game provided by the information processing system S (game apparatus G) of the present embodiment will be described using an example. Before starting the game, the player downloads in advance a dedicated application from the server 1000 to the player terminal 1 and registers a player ID in the server 1000. When the application is activated, the player terminal 1 receives information stored in the server 1000 such as deck information, play history information, and the like described below and displays a game screen on the touch panel 26.

In the present embodiment, the details of the game played by the player are not particularly limited. For example, the player can possess a plurality of types of game content provided by a game operator. Specifically, the player can perform a lottery for determining any of the plurality of types of game content using in-game currency. The player can possess the game content won in the lottery. Further, the player can play a rhythm game, a nurture game, a roll playing game (RPG), an action game, or the like using the possessed game content. In the present embodiment, as an example, a character is associated with the game content, and the character associated with the game content used in the game is displayed on the game screen.

In the present embodiment, a plurality of pieces of game content are included in one game application. The player can select game content and play a desired game. When the player selects the game content, various pieces of information necessary for playing the game are loaded from the storage device 18 to the storage unit 12 in the player terminal 1. The game application is updated regularly or irregularly. When the update is performed, the player terminal 1 receives new data from the server 1000 and stores the new data in the storage device 18 or the storage unit 12.

In this manner, the player terminal 1 performs processing of reading data necessary for playing the game (hereinafter referred to as loading processing), such as loading data in the player terminal 1 and loading (downloading) data from the server 1000.

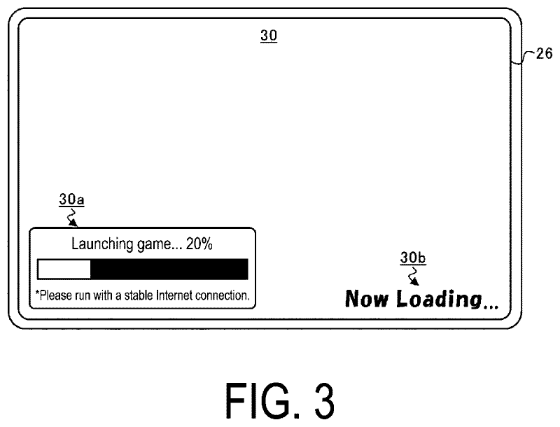

FIG. 3 is a diagram illustrating an example of a standby screen 30. During the loading processing, the standby screen 30 is displayed on the display 26. That is, the standby screen 30 is displayed while the data is downloaded from the server 1000 to the player terminal 1 or while the data is read from the storage device 18 to a memory such as the storage unit 12 in the player terminal 1. First standby information 30a and second standby information 30b are displayed on the standby screen 30. The first standby information 30a is information indicating a time period until completion of the data loading. As the first standby information 30a, “Launching game . . . N % (N is 0 to 100)” is displayed, and the progress status of the loading processing is visually displayed below the first standby information 30a. “Now Loading” is displayed as the second standby information 30b, which indicates that the data is currently being loaded. In this way, during the data loading, information indicating that the data is being loaded is displayed on the standby screen 30.

The first standby information 30a and the second standby information 30b are merely examples. Only one of the first standby information 30a or the second standby information 30b may be displayed on the standby screen 30. In addition to the first standby information 30a and the second standby information 30b, information indicating that the data is being loaded may be displayed.

The player cannot play the game until completion of the loading processing. When a time period required for the loading processing is long, only the standby screen 30 is displayed for a long time, and thus the player may feel fatigued. In this regard, it is conceivable to display a predetermined image on the standby screen 30, such as displaying a video on the standby screen 30. However, when an image far removed from the player's preference is displayed on the standby screen 30, player fatigue is not eliminated. Further, when the same image is repeatedly displayed on the standby screen 30, the player inevitably feels fatigued.

In view of this, the present embodiment provides a custom function that enables the standby screen 30 to be customized. In the custom function, the player can set an image to be displayed on the standby screen 30 and a display position of the image. Hereinafter, the custom function of the standby screen 30 will be described in detail.

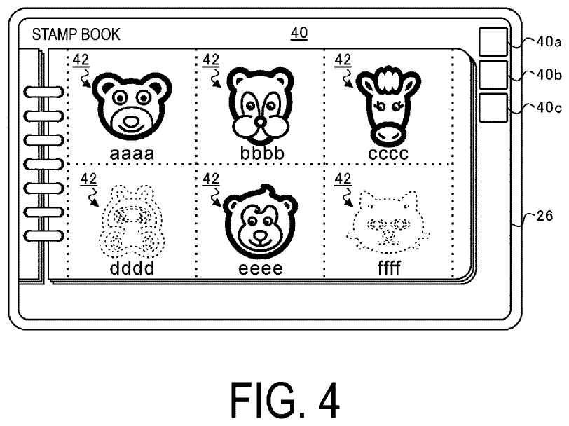

FIG. 4 is a diagram for describing an example of a stamp book top screen 40. When a predetermined operation portion is operated on the game screen, the stamp book top screen 40 illustrated in FIG. 4 is displayed. A plurality of types of stamp images 42 are displayed on the stamp book top screen 40. The stamp images 42 are images that can be displayed on the standby screen 30. Here, each stamp image 42 is an image of a character associated with game content used in the game. Each character has a name, and the name of the character is written below the stamp image 42 on the stamp book top screen 40.

The player can execute a lottery game for acquiring a plurality of types of stamp images 42 provided from the game operator. The player can execute the lottery game by, for example, using a lottery ticket, consuming in-game currency, clearing a predetermined game, achieving a presented mission (task), and the like. The lottery ticket may be given to the player as a reward of the game, for example.

In the lottery game, a stamp image 42 to be given to the player is randomly determined by lottery from among the plurality of types of provided stamp images 42. The player can possess the stamp image 42 won in the lottery. In addition, when a stamp image 42 that has been already acquired is determined by the lottery, a first predetermined number of exchange tickets may be given. In this case, the player may be able to possess a stamp image 42 selected from among given stamp images 42 by consuming a second predetermined number of exchange tickets, the second predetermined number being larger than the first predetermined number.

On the stamp book top screen 40, a stamp image 42 possessed by the player is normally displayed in color. On the other hand, on the stamp book top screen 40, a stamp image 42 not possessed by the player is displayed in a translucent manner. In FIG. 4, the stamp image 42 not possessed by the player is indicated by a broken line.

In the present embodiment, the stamp image 42 not possessed by the player is displayed in a translucent manner, and thus the player can identify which image is the unpossessed stamp image 42. However, on the stamp book top screen 40, nothing may be displayed for the stamp image 42 not possessed by the player.

In addition, one page of the stamp book is displayed on the stamp book top screen 40. Here, six stamp images 42 are assigned to one page of the stamp book. For example, when a flick operation in the left-right direction is input to the display 26, the displayed page of the stamp book is switched, and other stamp images 42 are displayed. In this manner, on the stamp book top screen 40, all the provided stamp images 42 and the stamp images 42 possessed by the player are displayed in an identifiable manner.

In addition, a stamp search button 40a, a stamp settings button 40b, and a stamp acquisition button 40c are provided at an upper right portion of the stamp book top screen 40. When the stamp search button 40a is operated, a search screen (not illustrated) is displayed. On the search screen, the stamp image 42 can be searched for using a character name, various parameters associated with the character, and the like. When the stamp acquisition button 40c is operated, a lottery screen (not illustrated) is displayed. As described above, the player can execute the lottery game on the lottery screen. When the stamp settings button 40b is operated, a stamp settings screen 50 is displayed.

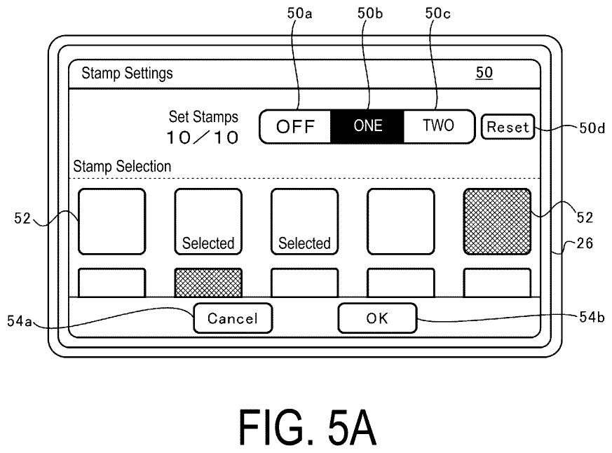

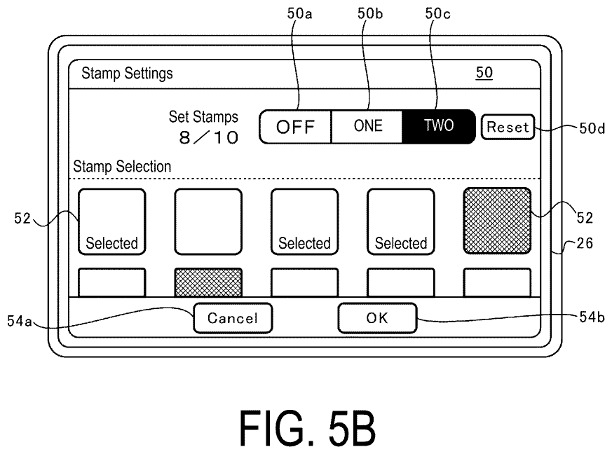

FIG. 5A is a first diagram for describing the stamp settings screen 50. FIG. 5B is a second diagram for describing the stamp settings screen 50. On the stamp settings screen 50, the player can select and set the stamp image 42 that can be displayed on the standby screen 30. The stamp settings screen 50 is provided with an OFF setting button 50a, a one-image setting button 50b, and a two-image setting button 50c. In the present embodiment, the player can select any of an OFF setting, a one-image setting, or a two-image setting as the display setting of the standby screen 30.

The OFF setting is a setting for hiding the stamp image 42 on the standby screen 30. In a state where the OFF setting is selected (hereinafter, referred to as an OFF setting state), no stamp image 42 is displayed on the standby screen 30. However, in the present embodiment, a one-panel image is displayed in the OFF setting state. The one-panel image is an image provided separately from the stamp image 42, and is an image that the player cannot set for display on the standby screen 30.

A plurality of types of one-panel images are provided, and, in the OFF setting state, a one-panel image randomly determined by lottery is displayed on the standby screen 30. The player can select the OFF setting state by operating the OFF setting button 50a. When an enter button 54b described below is operated in a state where the OFF setting state is selected, the display setting is set to the OFF setting.

The one-image setting is a setting for displaying one stamp image 42 on the standby screen 30. In a state where the one-image setting is selected (hereinafter, referred to as a one-image setting state), one stamp image 42 is displayed at the center of the standby screen 30 in a width direction. The player can select the one-image setting state by operating the one-image setting button 50b. Then, when the enter button 54b is operated in a state where the one-image setting state is selected, the display setting is set to the one-image setting.

The two-image setting is a setting for displaying two stamp images 42 on the standby screen 30. In a state where the two-image setting is selected (hereinafter, referred to as a two-image setting state), two stamp images 42 are displayed side by side in the width direction of the standby screen 30. The player can select the two-image setting state by operating the two-image setting button 50c. Then, when the enter button 54b is operated in a state where the two-image setting state is selected, the display setting is set to the two-image setting.

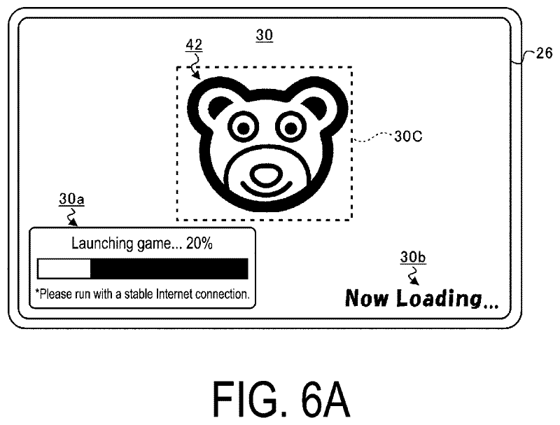

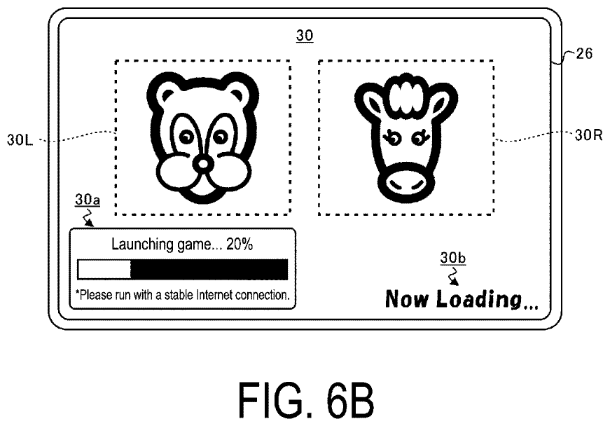

FIG. 6A is a diagram for describing the standby screen 30 in the one-image setting state. In the one-image setting state, as illustrated in FIG. 6A, one stamp image 42 is displayed in a center display region 30C. The center display region 30C is located at the center of the standby screen 30 in the width direction. Also in the one-image setting state, the first standby information 30a and the second standby information 30b are displayed on the standby screen 30. The center display region 30C is set at a position not overlapping the first standby information 30a or the second standby information 30b.

FIG. 6B is a diagram for describing the standby screen 30 in the two-image setting state. In the two-image setting state, as illustrated in FIG. 6B, one stamp image 42 is displayed in each of a left display region 30L and a right display region 30R. The left display region 30L is located to the left of the center of the standby screen 30 in the width direction, and the right display region 30R is located to the right of the center of the standby screen 30 in the width direction. Also in the two-image setting state, the first standby information 30a and the second standby information 30b are displayed on the standby screen 30. The left display region 30L and the right display region 30R are set at positions not overlapping the first standby information 30a or the second standby information 30b.

In this manner, the player can set the number of the stamp images 42 to be displayed on the standby screen 30 and the display position of each stamp image 42 by setting the one-image setting state or the two-image setting state.

Here, the player can select and set up to ten stamp images 42 on the stamp settings screen 50 for each of the one-image setting state and the two-image setting state. The stamp settings screen 50 is provided with a stamp display region 52 for displaying each stamp image 42. Although not illustrated in FIGS. 5A and 5B, the stamp image 42 is displayed in the stamp display region 52 in an identifiable manner. The player can select the stamp image 42 displayed in the stamp display region 52 by tapping the stamp display region 52.

For example, it is assumed that the one-image setting button 50b is operated and the one-image setting state is selected, as illustrated in FIG. 5A. In this state, the player can select up to ten stamp images 42 for the one-image setting. Further, for example, it is assumed that the two-image setting button 50c is operated and the two-image setting state is selected, as illustrated in FIG. 5B. In this state, the player can select up to ten stamp images 42 for the two-image setting. Hereinafter, the state of the stamp image 42 currently set as an image that can be displayed on the standby screen 30 is referred to as a selected state.

In the stamp display region 52 corresponding to the stamp image 42 in the selected state, “selected” is superimposed and displayed. The player can set only the possessed stamp image 42 to the selected state. The stamp display region 52 corresponding to the stamp image 42 not possessed by the player is grayed out and displayed as indicated by cross-hatching in the figure.

When the stamp display region 52 corresponding to the stamp image 42 in the selected state is tapped, the selected state of the stamp image 42 transitions to a provisional release state. When the stamp display region 52 corresponding to the stamp image 42 not currently in the selected state is tapped, the stamp image 42 enters a provisionally selected state. The number of the stamp images 42 currently in the selected state or the provisionally selected state is displayed to the left of the OFF setting button 50a. At this time, in a state where the one-image setting button 50b is selected, the number of the stamp images 42 in the selected state or the provisionally selected state for the one-image setting is displayed. In addition, in a state where the two-image setting button 50c is selected, the number of the stamp images 42 in the selected state or the provisionally selected state for the two-image setting is displayed.

A reset button 50d is provided to the right of the two-image setting button 50c. When the reset button 50d is operated, the stamp images 42 in the selected state and the provisionally selected state are reset. In addition, a cancel button 54a and the enter button 54b are provided at a lower portion of the stamp settings screen 50. When the cancel button 54a is operated, the operation performed so far is canceled, and the stamp settings screen 50 is hidden. When the cancel button 54a is operated, the display setting and the stamp image 42 in the selected state enter a state before the stamp settings screen 50 is displayed.

When the enter button 54b is operated, the stamp image 42 in the provisionally selected state is updated to the selected state. In this case, all the stamp images 42 in the selected state are stored in association with the one-image setting state or the two-image setting state.

In a case where the OFF setting button 50a is selected when the enter button 54b is operated, the display setting of the standby screen 30 is set to the OFF setting. When the enter button 54b is operated, the display setting of the standby screen 30 is set to the one-image setting in a case where the one-image setting button 50b is selected, and the display setting of the standby screen 30 is set to the two-image setting in a case where the two-image setting button 50c is selected.

As described above, the player can set up to ten stamp images 42 to the selected state for each of the one-image setting state and the two-image setting state. When the standby screen 30 is displayed, any stamp image 42 is randomly determined by lottery from among the stamp images 42 set by the player. Then, the determined stamp image 42 is displayed on the standby screen 30.

Specifically, in the one-image setting state, one stamp image 42 is determined from among the stamp images 42 set to the selected state by the player. Then, the determined stamp image 42 is displayed in the center display region 30C of the standby screen 30. In the two-image setting state, two stamp images 42 are determined from among the stamp images 42 set to the selected state by the player. Then, the determined two stamp images 42 are displayed in the left display region 30L and the right display region 30R of the standby screen 30.

The stamp images 42 may include a special stamp image that can be set to the selected state only in the one-image setting state and that cannot be set to the selected state in the two-image setting state. The special stamp image is configured to be larger than the normal stamp image 42, for example. In this manner, some of the stamp images 42 may be capable of being set to the selected state only in one of the one-image setting state or the two-image setting state.

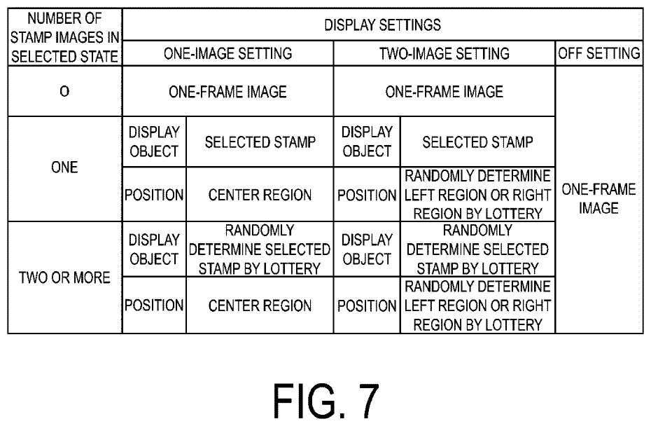

FIG. 7 is a diagram for describing a relationship between the number of the stamp images 42 displayed on the standby screen 30 and the number of the stamp images 42 in the selected state. The image to be displayed on the standby screen 30 is determined every time the standby screen 30 is displayed. For example, when the display setting is the OFF setting, a one-panel image is displayed on the standby screen 30. The one-panel image displayed at this time is randomly determined by lottery every time the standby screen 30 is displayed.

In addition, when the display setting is the one-image setting, the stamp image 42 to be displayed on the standby screen 30 is determined as follows depending on the number of the stamp images 42 in the selected state. That is, when the number of the stamp images 42 in the selected state for the one-image setting is zero, a one-panel image is displayed on the standby screen 30. The one-panel image displayed at this time is randomly determined by lottery every time the standby screen 30 is displayed. However, when the number of the stamp images 42 in the selected state for the one-image setting is zero, the one-panel image does not need to be displayed on the standby screen 30.

When the number of the stamp images 42 in the selected state for the one-image setting is one, one stamp image 42 in the selected state is displayed in the center display region 30C of the standby screen 30. Therefore, in this case, every time the standby screen 30 is displayed, one stamp image 42 selected by the player is definitely displayed in the center display region 30C.

In addition, when the number of the stamp images 42 in the selected state for the one-image setting is two or more, a lottery for randomly determining any one of the plurality of stamp images 42 in the selected state is performed. Then, the stamp image 42 in the selected state determined by the lottery is displayed in the center display region 30C of the standby screen 30. Therefore, in this case, every time the standby screen 30 is displayed, any one of the stamp images 42 in the selected state for the one-image setting is displayed in the center display region 30C.

In addition, when the display setting is the two-image setting, the stamp image 42 to be displayed on the standby screen 30 is determined as follows depending on the number of the stamp images 42 in the selected state. That is, when the number of the stamp images 42 in the selected state for the two-image setting is zero, a one-panel image is displayed on the standby screen 30. The one-panel image displayed at this time is randomly determined by lottery every time the standby screen 30 is displayed. However, when the number of the stamp images 42 in the selected state for the two-image setting is zero, the one-panel image does not need to be displayed on the standby screen 30.

When the number of the stamp images 42 in the selected state for the two-image setting is one, one stamp image 42 in the selected state is displayed in the left display region 30L or the right display region 30R of the standby screen 30. In this case, whether the display region for displaying the stamp image 42 is the left display region 30L or the right display region 30R is randomly determined by lottery. Therefore, when the number of the stamp images 42 in the selected state for the two-image setting is one, one stamp image 42 selected by the player is displayed in the left display region 30L or the right display region 30R every time the standby screen 30 is displayed.

However, when the display setting is the two-image setting and the number of the stamp images 42 in the selected state for the two-image setting is one, the stamp image 42 may be displayed in a preset display region of the left display region 30L and the right display region 30R. Further, for example, when the display setting is the two-image setting and the number of the stamp images 42 in the selected state for the two-image setting is one, the stamp image 42 may be displayed in the center display region 30C. Further, the stamp image 42 in the selected state may be displayed in one of the left display region 30L and the right display region 30R, and a one-panel image may be displayed in the other.

In addition, when the number of the stamp images 42 in the selected state for the two-image setting is two or more, a lottery for randomly determining any two of the plurality of stamp images 42 in the selected state is performed. In addition, whether to display the determined two stamp images 42 in the left display region 30L or the right display region 30R is determined by lottery. Therefore, in this case, every time the standby screen 30 is displayed, any two of the stamp images 42 in the selected state for the two-image setting are displayed in the left display region 30L or the right display region 30R.

As described above, according to the present embodiment, processing is executed in which the player selects one or more objects from among the plurality of types of stamp images 42 (objects) that can be displayed on the standby screen 30 displayed during data loading. Further, processing is executed in which the stamp image 42 (object) selected by the player is stored as the stamp image 42 (displayable object) in the selected state, and the display setting (position information) for defining the display position of the stamp image 42 (object) on the standby screen 30 is set based on an operation input from the player. Then, processing is executed in which, during the data loading, the first standby information 30a and the second standby information 30b (information indicating that the data is being loaded) are displayed on the standby screen 30, and the stamp image 42 (object) stored as the stamp image 42 (displayable object) in the selected state is displayed on the standby screen 30 based on the display setting (position information).

Further, based on an operation input from the player, processing of setting the number of the stamp images 42 (objects) to be displayed on the standby screen 30 (processing of setting the first setting or the second setting) is executed. Further, processing is executed in which the same number of the stamp images 42 (displayable objects) as the number of the stamp images 42 (objects) to be displayed on the standby screen 30 are determined by lottery from among the stored stamp images 42 (displayable objects) in the selected state. Then, all the stamp images 42 (displayable objects) determined by the lottery are displayed on the standby screen 30.

Further, the processing of determining the stamp image 42 (displayable object) by the lottery is executed every time the standby screen 30 is displayed.

Thus, according to the present embodiment, the stamp image 42 desired by the player is displayed on the standby screen 30. Moreover, the player can also determine the number of the stamp images 42 to be displayed on the standby screen 30 and the position thereof. This improves player interest in the standby screen 30 and suppresses player fatigue.

### Specific Control Processing in Player Terminal 1

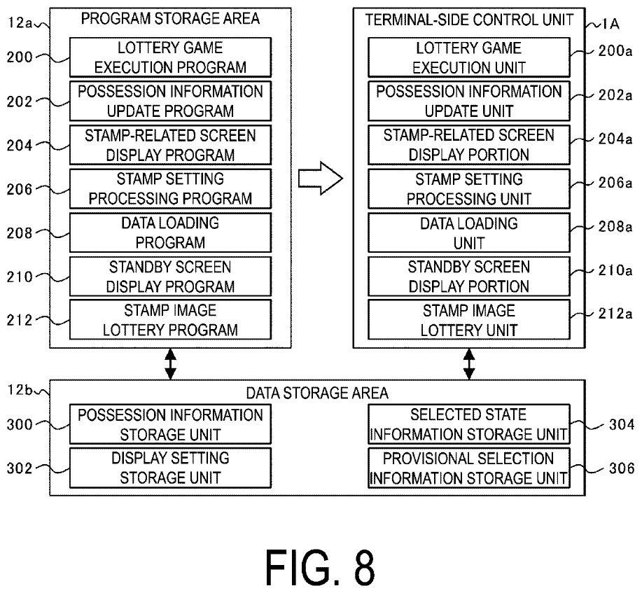

Next, specific control processing in the player terminal 1 for executing the above-described game will be described. FIG. 8 is a diagram for describing a configuration of the storage unit 12 in the player terminal 1 and a function thereof as a computer. The storage unit 12 is provided with a program storage area 12a and a data storage area 12b. When the application is activated, the CPU 10 stores a terminal-side control program (module) in the program storage area 12a.

The terminal-side control program includes a lottery game execution program 200, a possession information update program 202, a stamp-related screen display program 204, a stamp setting processing program 206, a data loading program 208, a standby screen display program 210, and a stamp image lottery program 212. The above-described programs are merely examples, and many other programs are also provided in the program storage area 12a.

The CPU 10 operates each program stored in the program storage area 12a and updates the data in each storage unit of the data storage area 12b. Then, the CPU 10 causes the player terminal 1 (computer) to function as a terminal-side control unit 1A by operating each program stored in the program storage area 12a.

The terminal-side control unit 1A includes a lottery game execution unit 200a, a possession information update unit 202a, a stamp-related screen display portion 204a, a stamp setting processing unit 206a, a data loading unit 208a, a standby screen display portion 210a, and a stamp image lottery unit 212a. Specifically, the CPU 10 operates the lottery game execution program 200 to cause the computer to function as the lottery game execution unit 200a.

Similarly, the CPU 10 operates the possession information update program 202, the stamp-related screen display program 204, the stamp setting processing program 206, the data loading program 208, the standby screen display program 210, and the stamp image lottery program 212 to cause the computer to respectively function as the possession information update unit 202a, the stamp-related screen display portion 204a, the stamp setting processing unit 206a, the data loading unit 208a, the standby screen display portion 210a, and the stamp image lottery unit 212a.

The lottery game execution unit 200a executes processing for executing the above-described lottery game based on an operation input from the player.

The possession information update unit 202a updates possession information of the stamp image 42 newly acquired in the lottery game.

The stamp-related screen display portion 204a controls display of screens relating to the stamp image 42, such as the stamp book top screen 40 and the stamp settings screen 50.

The stamp setting processing unit 206a performs, based on an operation input from the player, processing of setting the display setting and processing of setting the stamp image 42 in the selected state for each display setting.

The data loading unit 208a performs processing of loading data from the storage device 18 to the storage unit 12 and processing of downloading data from the server 1000.

The standby screen display portion 210a performs processing for displaying the standby screen 30.

The stamp image lottery unit 212a determines, by lottery, the stamp image 42 to be displayed on the standby screen 30.

In the data storage area 12b, a possession information storage unit 300, a display setting storage unit 302, a selected state information storage unit 304, and a provisional selection information storage unit 306 are provided as storage units for storing data. Note that the above-described storage units are merely examples, and many other storage units may be provided in the data storage area 12b.

The possession information storage unit 300 stores possession information indicating possession or non-possession of each stamp image 42.

The display setting storage unit 302 stores the current display setting. That is, any of the OFF setting, the one-image setting, or the two-image setting is stored as the current display setting.

The selected state information storage unit 304 stores, as selected state information, the stamp image 42 in the selected state corresponding to the one-image setting and the stamp image 42 in the selected state corresponding to the two-image setting.

The provisional selection information storage unit 306 stores the stamp image 42 in the provisionally selected state based on an operation input from the player while the stamp settings screen 50 is displayed. That is, the provisional selection information storage unit 306 functions as a work area when the player selects the stamp image 42 in the selected state.

Hereinafter, a part of processing executed by the terminal-side control unit 1A will be described.

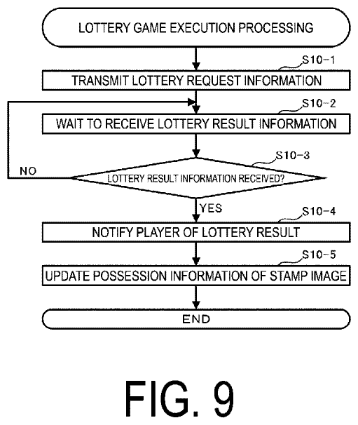

FIG. 9 is a flowchart for describing an example of lottery game execution processing in the player terminal 1. This processing is executed by the lottery game execution unit 200a when an operation input for executing the lottery game is performed by the player. The lottery game execution unit 200a transmits lottery request information to the server 1000 (S10-1). The lottery request information is information for requesting the server 1000 to execute a lottery for determining the stamp image 42 to be given to the player.

Although detailed description is omitted, when receiving the lottery request information, the server 1000 executes the lottery game for determining the stamp image 42. When the lottery game is executed, a lottery result, that is, lottery result information indicating the stamp image 42 won in the lottery is set. The lottery game execution unit 200a waits until the lottery result information is received (S10-2), and when the lottery result information is received (YES in S10-3), the lottery game execution unit 200a plays an animation for notifying the player of the won stamp image 42 (S10-4). Further, when the player does not possess the won stamp image 42, the possession information update unit 202a updates the possession information of the won stamp image 42 from “not possessed” to “possessed” in the possession information storage unit 300 (S10-5).

Although detailed description is omitted, the possession information of the stamp image 42 is also managed in the server 1000. Further, the lottery is executed in the server 1000 here, but may be executed in the player terminal 1.

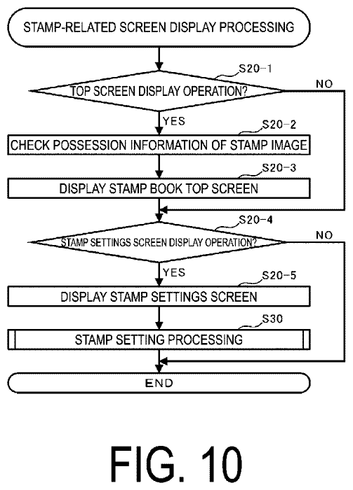

FIG. 10 is a flowchart for describing an example of stamp-related screen display processing in the player terminal 1. This processing is executed by the stamp-related screen display portion 204a. Here, processing for displaying the stamp book top screen 40 and the stamp settings screen 50 will be described, and description of processing of displaying other screens will be omitted.

When a top screen display operation for displaying the stamp book top screen 40 is input (YES in S20-1), the stamp-related screen display portion 204a checks the possession information of the stamp images 42 in the possession information storage unit 300 (S20-2). Then, the stamp-related screen display portion 204a displays the stamp book top screen 40 based on the possession information checked in S20-2 (S20-3).

When a stamp settings screen display operation for displaying the stamp settings screen 50 is input (YES in S20-4), the stamp-related screen display portion 204a displays the stamp settings screen 50 (S20-5). When the stamp settings screen 50 is displayed, the stamp setting processing unit 206a starts stamp setting processing (S30).

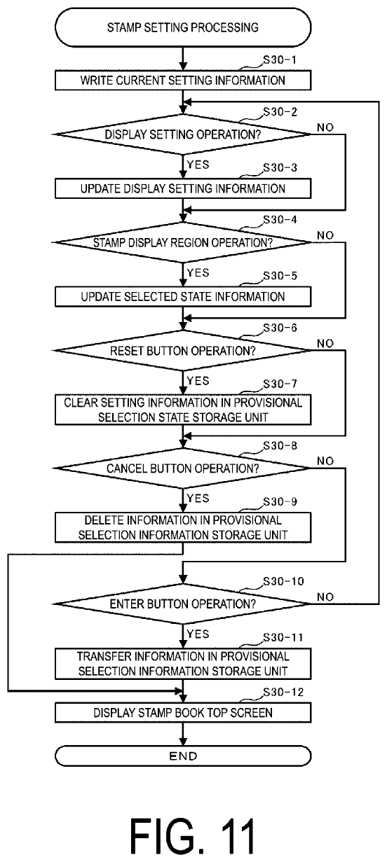

FIG. 11 is a flowchart for describing an example of the stamp setting processing in the player terminal 1. The stamp setting processing unit 206a writes the current setting information of the stamp image 42 in the provisional selection information storage unit 306 (S30-1). Specifically, the stamp setting processing unit 206a writes, in the provisional selection information storage unit 306, display setting information indicating the current display setting (the OFF setting, the one-image setting, or the two-image setting) stored in the display setting storage unit 302 and the selected state information indicating the stamp image 42 in the selected state for each display setting, which is stored in the selected state information storage unit 304.

When a display setting operation for switching the display setting, that is, an operation of the OFF setting button 50a, the one-image setting button 50b, or the two-image setting button 50c is input to the stamp settings screen 50 (YES in S30-2), the stamp setting processing unit 206a updates the display setting information in the provisional selection information storage unit 306 (S30-3).

When the stamp display region 52 is operated on the stamp settings screen 50 (YES in S30-4), the stamp setting processing unit 206a updates the selected state information in the provisional selection information storage unit 306, that is, the provisionally selected state for each stamp image 42 (S30-5).

When the reset button 50d is operated on the stamp settings screen 50 (YES in S30-6), the stamp setting processing unit 206a clears the selected state information corresponding to the currently selected display setting in the provisional selection information storage unit 306 (S30-7).

When the cancel button 54a is operated on the stamp settings screen 50 (YES in S30-8), the stamp setting processing unit 206a deletes the information in the provisional selection information storage unit 306 (S30-9) and displays the stamp book top screen 40 (S30-12). In this case, the stamp setting processing is terminated without changing the display setting and the stamp image 42 in the selected state.

When the enter button 54b is operated on the stamp settings screen 50 (YES in S30-10), the stamp setting processing unit 206a transfers the display setting information in the provisional selection information storage unit 306 to the display setting storage unit 302, and transfers the selected state information in the provisional selection information storage unit 306 to the selected state information storage unit 304 (S30-11). In this case, the stamp setting processing unit 206a displays the stamp book top screen 40 (S30-12). Accordingly, the display setting and the stamp image 42 in the selected state are changed.

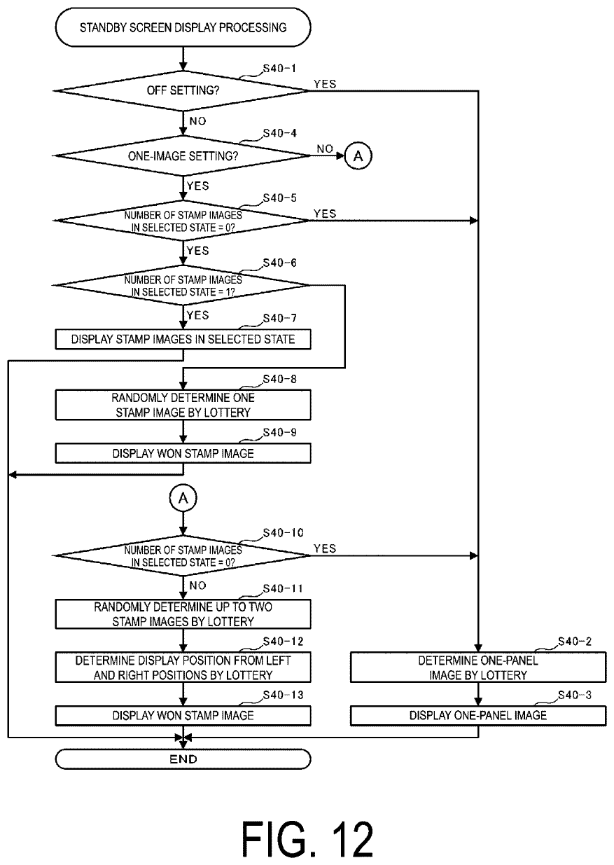

FIG. 12 is a flowchart for describing an example of standby screen display processing in the player terminal 1. This processing is executed by the standby screen display portion 210a and the stamp image lottery unit 212a when the data loading unit 208a starts processing of loading data into the storage unit 12.

When the current display setting stored in the display setting storage unit 302 is the OFF setting (YES in S40-1), the standby screen display portion 210a determines, by lottery, any one of the plurality of types of prepared one-panel images (S40-2). Then, the standby screen display portion 210a displays the one-panel image determined in S40-2 on the standby screen 30 (S40-3).

When the current display setting stored in the display setting storage unit 302 is the one-image setting (YES in S40-4), the standby screen display portion 210a determines whether the number of the stamp images 42 in the selected state for the one-image setting stored in the selected state information storage unit 304 is zero (S40-5). When the number of the stamp images 42 in the selected state for the one-image setting is zero (YES in S40-5), the standby screen display portion 210a performs the processing in S40-2 and S40-3 described above, and displays a one-panel image on the standby screen 30.

When the number of the stamp images 42 in the selected state for the one-image setting is one (YES in S40-6), the standby screen display portion 210a displays the stamp image 42 in the selected state on the standby screen 30 (S40-7). Here, the standby screen display portion 210a displays the stamp image 42 at the coordinates corresponding to the center display region 30C.

In addition, when the number of the stamp images 42 in the selected state for the one-image setting is not one (NO in S40-6), that is, when the number of the stamp images 42 in the selected state for the one-image setting is two or more, the stamp image lottery unit 212a executes a lottery for randomly determining one of the plurality of stamp images 42 in the selected state (S40-8). Then, the standby screen display portion 210a displays the stamp image 42 determined in S40-8 on the standby screen 30 (S40-9). Here, the standby screen display portion 210a displays the stamp image 42 at the coordinates corresponding to the center display region 30C.

In addition, when the current display setting stored in the display setting storage unit 302 is not the one-image setting (NO in S40-4), that is, when the current display setting is the two-image setting, the standby screen display portion 210a determines whether the number of the stamp images 42 in the selected state for the two-image setting stored in the selected state information storage unit 304 is zero (S40-10). When the number of the stamp images 42 in the selected state for the two-image setting is zero (YES in S40-10), the standby screen display portion 210a performs the processing in S40-2 and S40-3 described above, and displays a one-panel image on the standby screen 30.

When the number of the stamp images 42 in the selected state for the two-image setting is one or more (NO in S40-10), the stamp image lottery unit 212a executes a lottery for randomly determining one or two of the stamp images 42 in the selected state (S40-11). Here, when the number of the stamp images 42 in the selected state is one, one stamp image 42 in the selected state is determined, and when the number of the stamp images 42 in the selected state is two or more, two stamp images 42 are determined by lottery.

Then, the standby screen display portion 210a determines, by lottery, the left display region 30L or the right display region 30R as the position for displaying the stamp image 42 (S40-12). Then, the standby screen display portion 210a displays the stamp image 42 won in S40-11 at the coordinates corresponding to the display position determined in S40-12 (S40-13). Here, the stamp image 42 won in the first lottery in S40-11 is displayed at the display position determined in S40-12. In addition, when two stamp images 42 are determined, the stamp image 42 won in the second lottery is displayed at the remaining display position.

It is only required that the execution timing of the processing of determining the stamp image 42 to be displayed and the display region for displaying the stamp image 42 be earlier than the processing of displaying the stamp image 42. For example, when the game application is activated, the stamp image 42 and the display region may be determined and stored in advance. In this case, it is only required that the stamp image 42 be displayed based on the stored information at the timing of displaying the stamp image 42.

Here, an aspect of the embodiment has been described with reference to the accompanying drawings. However, it goes without saying that the present invention is not limited to the above-described embodiment. It is apparent to those skilled in the art that various modifications and corrections can be made within the scope of the claims, and it should be understood that such modifications and corrections also obviously fall within the technical scope of the present invention.

In the above embodiment, a case has been described in which the object that can be displayed on the standby screen 30 displayed during the data loading is the stamp image 42. However, details of the object that can be displayed on the standby screen 30 are not particularly limited. For example, the object that can be displayed on the standby screen 30 may be implemented as one image or a moving image. In any case, it is only required that a plurality of types of objects that can be displayed on the standby screen 30 be provided.

In the above embodiment, the OFF setting is provided as a display setting pattern, but the OFF setting is not essential. In the OFF setting state, a one-panel image is randomly displayed, but only one type of image may be displayed in the OFF setting state. Furthermore, the OFF setting is not essential, and only the one-image setting and the two-image setting may be provided. Further, it may be possible to make a setting so as to display any one or more images determined by lottery from among the stamp images 42 and images of types different from those of the stamp images 42, such as the above-described one-panel image.

In the above embodiment, the player can select the center display region 30C as the display position of the stamp image 42 by selecting the one-image setting. Further, the player can select the left display region 30L and the right display region 30R as the display positions of the stamp images 42 by selecting the two-image setting. However, the player may be able to set the display position of the stamp image 42 in more detail. For example, the player may be able to set coordinates on the screen as the display position of the stamp image 42.

Further, for example, the player may be able to set the display position for each stamp image 42. At this time, the display position may be able to be set depending on the number of the stamp images 42 displayed at the same time. Specifically, for example, when the two-image setting button 50c is selected on the stamp settings screen 50, an operation portion that enables selection of the left display region 30L or the right display region 30R is displayed. Then, when the stamp display region 52 is operated in a state where the left display region 30L is selected, the display position of the stamp image 42 in the operated stamp display region 52 is set to the left display region 30L. Similarly, when the stamp display region 52 is operated in a state where the right display region 30R is selected, the display position of the stamp image 42 in the operated stamp display region 52 is set to the right display region 30R.

In this case, for example, “left” may be displayed in the stamp display region 52 of the stamp image 42 in which the left display region 30L is set, and “right” may be displayed in the stamp display region 52 of the stamp image 42 in which the right display region 30R is set. Accordingly, it is easy to identify whether to display the stamp image 42 in the left display region 30L or the right display region 30R on the stamp settings screen 50. In this example, in the two-image setting state, one stamp image 42 can be set in only one of the left display region 30L or the right display region 30R.

However, one stamp image 42 may be able to be set in both the left display region 30L and the right display region 30R. In this case, it is desirable to perform control so as not to display the same stamp image 42 in both the left display region 30L and the right display region 30R on the standby screen 30. In any case, it is only required that the position information for defining the display position of the object on the standby screen 30 be set based on an operation input from the player.

In the embodiment described above, the stamp image 42 to be displayed on the standby screen 30 is determined by lottery. However, the stamp image 42 to be displayed on the standby screen 30 may be determined according to a preset order, for example. In this case, for example, the player may be able to set the display order of the stamp images 42.

In the above embodiment, the stamp image 42 to be displayed on the standby screen 30 is determined every time the standby screen 30 is displayed. However, the stamp image 42 to be displayed on the standby screen 30 may be determined every time the standby screen 30 is displayed a predetermined number of times equal to or more than two. In this case, for example, the same stamp image 42 is displayed on the standby screen 30 consecutively the predetermined number of times.

The control processing described in the above embodiment is merely an example. In the above-described embodiment, a case has been described in which the control processing for executing the game is executed in the player terminal 1. That is, in the above embodiment, the control processing for executing the game is executed only in the player terminal 1. In this case, only the player terminal 1 functions as the game apparatus G. However, a part of the control processing described above may be executed in the server 1000. That is, the information processing system S, which is a client-server system including the player terminal 1 and the server 1000, may function as the game apparatus G.

In the above-described embodiment, the information processing program for implementing the game may be stored in a non-transitory computer-readable storage medium. In addition, the above-described embodiment may correspond to an information processing method for implementing each function and the steps illustrated in the flowcharts.

What is claimed is:

1. A non-transitory computer readable medium storing a program causing a computer to execute:
processing of causing a player to select one or more objects from among a plurality of types of objects displayable on a standby screen displayed during loading of data;
processing of storing the one or more objects selected by the player as one or more displayable objects;
processing of setting position information defining a display position of each of the one or more objects on the standby screen, based on an operation input from the player;
processing of displaying information indicating that the data is being loaded on the standby screen, during the loading of the data; and
processing of displaying the one or more objects stored as the one or more displayable objects on the standby screen based on the position information.

2. The non-transitory computer readable medium according to claim 1, wherein the program further causes the computer to execute:
processing of setting the number of objects to be displayed on the standby screen based on an operation input from the player; and
processing of selecting one or more objects to be displayed on the standby screen by lottery from among the one or more displayable objects that have been stored, the number of one or more objects to be displayed on the standby screen being the same as the number that has been set based on the operation input from the player, wherein the processing of displaying the one or more objects on the standby screen includes displaying all of the one or more displayable objects that have been selected by the lottery on the standby screen.

3. The non-transitory computer readable medium according to claim 1, wherein
the processing of selecting the one or more objects to be displayed on the standby screen by lottery is executed every time the standby screen is displayed.

4. An information processing method executed by one or more computers, the information processing method comprising:
by the one or more computers, processing of causing a player to select one or more objects from among a plurality of types of objects displayable on a standby screen displayed during loading of data;
by the one or more computers, processing of storing the one or more objects selected by the player as one or more displayable objects;
by the one or more computers, processing of setting position information defining a display position of each of the one or more objects on the standby screen, based on an operation input from the player;
by the one or more computers, processing of displaying, during the loading of the data, information indicating that the data is being loaded on the standby screen; and
by the one or more computers, processing of displaying the one or more objects stored as the one or more displayable objects on the standby screen based on the position information.

5. A game apparatus comprising:
one or more computers, wherein
the one or more computers execute:
processing of causing a player to select one or more objects from among a plurality of types of objects displayable on a standby screen displayed during loading of data;
processing of storing the one or more objects selected by the player as oner or more displayable objects;
setting position information defining a display position of each of the one or more objects on the standby screen, based on an operation input from the player; and
processing of displaying information indicating that the data is being loaded on the standby screen, during the loading of the data; and
displaying the one or more objects stored as the one or more displayable objects on the standby screen based on the position information.
